(19) United States
(12) Patent Application Publication
(10) Pub. No.: US 2026/0095091 A1
(43) Pub. Date: Apr. 2, 2026

(54) Hybrid Power Converter Circuit With Resonant Mode and Pulse Width Modulation Mode

(71) Applicant: TDK-Lambda Americas, Inc., Richardson, TX (US)

(72) Inventors: Eleftherios Doudousakis, Long Island City, NY (US); Gregory Laufman, Island Park, NY (US)

(21) Appl. No.: 18/902,131

(22) Filed: Sep. 30, 2024

(51) Int. Cl. H02M 3/00; H02M 1/00; H02M 1/38; H02M 3/335

(52) U.S. Cl. CPC H02M 3/01; H02M 1/0058; H02M 1/385; H02M 3/33592

(57) ABSTRACT

A power converter circuit, apparatus, and a corresponding method of operation. The power converter circuit includes a transformer dividing the power converter circuit into a primary side and a secondary side, a switching circuit disposed on the primary side, and a rectifier circuit disposed on the secondary side and configured to provide power to a load. The switching circuit operates in a resonant mode with zero voltage switching (ZVS) using a fixed duty cycle and a variable switching frequency that varies between a minimum frequency (Fmin) and a maximum frequency (Fmax) based on an amount of power output to the load above a threshold, and the switching circuit operates in a forward pulse width modulation (PWM) mode with ZVS using a fixed switching frequency and a duty cycle that varies based on the amount of power output to the load below the threshold.

### BACKGROUND

### Technical Field

Novel aspects of the present disclosure relate to the field of power converters and more particularly to a power converter circuit that can operate in either a resonant mode or a forward pulse width modulation mode based on the power provided to a load connected to the power converter circuit.

### Background

Power converters are devices that convert an input voltage to a different voltage. For example, a DC-DC converter converts a direct current input voltage to a different direct current output voltage. When the output voltage is higher than the input voltage, then the DC-DC converter is a colloquially termed a “boost converter” or “step-up” converter. A DC-DC converter that provides an output voltage that is lower than the input voltage is sometimes referred to as a “buck converter” or “step-down” converter.

Resonant topologies, including LLC, operate near 50% Duty Cycle (D) with Variable Switching Frequency (Fs) control. These resonant topologies work best over a relatively narrow band of input/output voltages and loads. At light loads or large input or output voltage variations, the ability to maintain zero voltage switching (ZVS) deteriorates, leading to increased power dissipation, higher component temperatures, lower efficiencies, and possible instability. Larger components make higher power applications (e.g., greater than 2 kW) impractical. To compensate, designers typically increase the amount of designed-in Primary Magnetizing Current (Imag), resulting in larger magnetics and semiconductor devices having increased losses and lower efficiency. However, Imag varies inversely with Fs, making it hard to balance. That practically limits LLC designs to about 2 kW. Pulse skipping (burst mode) can be employed to maintain regulation at light load/no load operation but is not practical for zero-up or constant-voltage-constant-current operation as it can lead to higher ripple and noise emitted by the PSU.

### SUMMARY OF THE INVENTION

Novel aspects of the present disclosure are directed to a power converter circuit comprising a transformer dividing the power converter circuit into a primary side and a secondary side, a switching circuit disposed on the primary side, and a rectifier circuit disposed on the secondary side and configured to provide power to a load. The switching circuit operates in a resonant mode with zero voltage switching (ZVS) using a fixed duty cycle and a variable switching frequency that varies between a minimum frequency (Fmin) and a maximum frequency (Fmax) based on an amount of power output to the load being above a threshold, and the switching circuit operates in a forward pulse width modulation (PWM) mode with ZVS using a fixed switching frequency and a duty cycle that varies based on the amount of power output to the load being below the threshold.

Novel aspects of the present disclosure are also directed to an apparatus comprising a power supply and a power converter circuit receiving power from the power supply. The power converter circuit comprising a transformer dividing the power converter circuit into a primary side and a secondary side, a switching circuit disposed on the primary side, and a rectifier circuit disposed on the secondary side and configured to provide power to a load. The switching circuit operates in a resonant mode with zero voltage switching (ZVS) using a fixed duty cycle and a variable switching frequency that varies between a minimum frequency (Fmin) and a maximum frequency (Fmax) based on an amount of power output to the load being above a threshold, and the switching circuit operates in a forward pulse width modulation (PWM) mode with ZVS using a fixed switching frequency and a duty cycle that varies based on the amount of power output to the load being below the threshold.

Novel aspects of the present disclosure are also directed to a method of operating a power converter circuit. The method includes a step of determining an amount of power output to a load relative to a threshold, and responsive to determining that the amount of power output is above the threshold, the method includes a step of causing the switching circuit to operate in a resonant mode with zero voltage switching (ZVS) using a fixed duty cycle and a variable switching frequency that varies between a minimum frequency (Fmin) and a maximum frequency (Fmax) based on an amount of the power output to the load. However, responsive to determining that the amount of power output is below the threshold, the method includes the step of causing the switching circuit to operate in a forward pulse width modulation (PWM) mode with ZVS using a fixed switching frequency and a duty cycle that varies based on the amount of the power output to the load.

Other aspects, embodiments and features of the invention will become apparent from the following detailed description of the invention when considered in conjunction with the accompanying figures. In the figures, each identical, or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE FIGURES

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 is a schematic diagram of a circuit configured to operate in a resonant mode and a forward pulse width modulation mode in accordance with an illustrative embodiment;

FIG. 2 is another schematic diagram of a circuit for configured to operate in a resonant mode and a forward pulse width modulation mode in accordance with an illustrative embodiment;

FIG. 3 is a schematic diagram of a signal generator for controlling a circuit configured to operate in a resonant mode and a forward pulse width modulation mode in accordance with an illustrative embodiment;

FIG. 4 is a schematic diagram of an apparatus implementing a circuit configured to operate in a resonant mode and a forward pulse width modulation mode in accordance with an illustrative embodiment;

FIG. 5 is a timing diagram of the circuit in FIG. 1 operating in a resonant mode in accordance with an illustrative embodiment;

FIG. 6 is a timing diagram of the circuit in FIG. 1 operating at the boundary between resonant mode and forward pulse width modulation mode in accordance with an illustrative embodiment;

FIG. 7 is a timing diagram of the circuit in FIG. 1 operating in forward pulse width modulation mode in accordance with an illustrative embodiment;

FIG. 8A is a timing diagram of circuit in FIG. 1 operating in forward pulse width modulation mode, but without locking Ip during an off time;

FIG. 8B is a timing diagram of a circuit with improved switching characteristics due to an output inductor;

FIG. 9 is flowchart of a process for operating the circuit of FIG. 1 in accordance with an illustrative embodiment;

FIG. 10 is a flowchart of a process for controlling a switching circuit to operate in a PWM mode with ZVS in accordance with an illustrative embodiment; and

FIG. 11 is a flowchart of a process for operating a switching circuit in resonant mode with ZVS in accordance with an illustrative embodiment.

### DETAILED DESCRIPTION

Electrical/electronic devices, such as those that might provide a load to a power supply/converter, designed to work when provided with a certain range of voltages and currents. A change in the power requirements of the load can be accommodated by changing the operating characteristics of the power supply/converter but can result in unintended effects or inefficient operation. Pulse width modulation (PWM) is a method of reducing the electrical power supplied to the load by switching the signal on and off at a high frequency. As the relative on-time of the PWM signal decreases (or increases), so does the average voltage of the signal. This average voltage provides an equivalent power while still maintaining full voltage. The PWM signal is controlled by switching frequency (Fs) and the relative duration of the on-time, i.e., “duty cycle”. D is the relative amount of time the PWM signal will be on and is expressed as a percentage. D is defined as switch on-time (Ton) divided by the switching cycle period (Ts), i.e., D=Tₒₙ/Tₛ=Tₒₙ×fₛ. The higher the duty cycle, the longer the switch conducting interval, and hence, the more input power is transferred to the output side providing that the switching frequency is constant. Usually when the output voltage is below the desired level due to load change the duty cycle is increased to raise the output voltage so that it stays at the desired level. When the line voltage drops, the output voltage will also dip. By increasing the duty cycle, the output voltage can be maintained. However, the maximum duty cycle of the primary switches is often limited to 50% to achieve the best efficiency and the input and output ripple cancellation.

From the power conversion efficiency point of view, the higher the duty cycle, the better the conversion efficiency. However, a wide input voltage power system requires the transformer turns ratio to be chosen so that the converter maintains the regulation at minimum input voltage with some voltage margin for the converter internal impedance associated losses. As a result, the converter will have increased primary side current due to low transformer turns ratio and too much voltage available when the input voltage is at highest point. This applies very high voltage stress to the secondary side switches so that higher voltage rated switches need to be used (i.e. less efficiency) and requires the converter to operate at very small duty cycle in order to maintain the regulation for a given output voltage. The increased current in the primary winding and switches of the switching circuit also leads to higher conduction and greater switching losses. Each of these drawbacks results in lower overall conversion efficiency and requires greater effort to remove the heat that is generated.

Another method of changing the electrical power supplied to the load by switching the signal on and off at a high frequency is Frequency Modulation. This mode of operation takes advantage of the slope of a transfer function of a resonant circuit. As the switching frequency of the signal to the resonant circuit increases (or decreases) the resonance allows less (or more) power to be transferred. D in this case remains constant at approximately 50%, excluding a small deadtime (DT) between switching devices, and the frequency is varied as needed. When the output voltage is below the desired level due to a load change or a line voltage drop, the frequency is decreased to raise the output voltage so that it stays at the desired level. There are, however, practical limitations on how far the frequency can be adjusted without introducing significantly negative impacts to other desired parameters, including, but not limited to, noise, ZVS, or efficiency.

Novel aspects of this disclosure recognize the need for a power converter circuit that can operate over a wider band of input/output voltage variations and in higher power applications, e.g., greater than 2 kW, while maintaining high efficiency, zero voltage switching, and rapid transient response. To this end, an improved power converter circuit is provided that operates in a resonant mode or a forward pulse width modulation (PWM) mode based on the load requirement of a load powered by the power converter circuit.

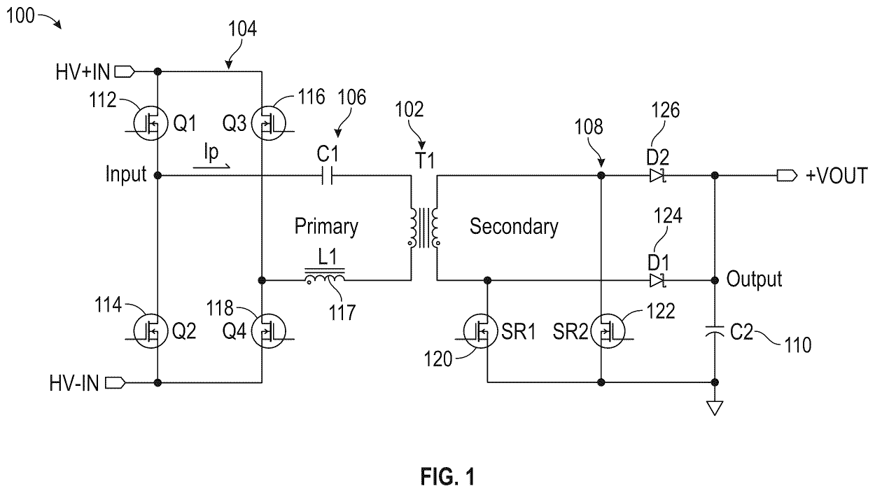

FIG. 1 is a schematic diagram of a power conversion circuit configured to operate in a resonant mode and a forward pulse width modulation mode in accordance with an illustrative embodiment. In particular, the power conversion circuit 100 operates in a resonant mode at high loads, e.g., between 50-100% of the full load, and forward pulse width modulation mode at low loads, e.g., less than 50% of the full load.

In the resonant mode, the duty cycle (D) is maintained at a fixed value and the switching frequency (Fs) is manipulated to provide a desired output voltage (Vout). During the resonant mode, power is delivered during each half of the switching cycle. The resonant tank has approximately unity gain and best optimized operation and efficiency, therefore, transformer turns ratio is designed such that the converter operates at this point at nominal input and output voltages. In the forward PWM mode, (hereinafter “PWM mode”), Fs is maintained at a fixed value and D varies to provide a desired Vout.

The power conversion circuit 100 includes a transformer 102 dividing the power converter circuit 100 into a primary side and a secondary side. A switching circuit 104 is disposed on the primary side of the switching circuit and is coupled to a resonant tank 106 that is in turn coupled to a primary winding of the transformer 102. The power conversion circuit 100 also includes a rectifier circuit 108 disposed on the secondary side and configured to provide power to a load, e.g., load 404 in FIG. 4. In the depicted embodiment, the rectifier circuit 108 is a full bridge rectifier circuit that includes an output capacitor 110 configured to transfer energy to the load but does not include an output inductor so that the power conversion circuit can provide a faster transient response and also reduced losses by allowing for lower inductance on inductor 117.

The switching circuit 104 generates a square waveform that excites the resonant tank 106, which outputs a resonant sinusoidal current that is scaled by the transformer 102 and rectified by the rectifier circuit 108. The output capacitor 110 filters the rectified AC current and outputs a DC voltage to a load.

In a non-limiting embodiment, the switching circuit 104 of FIG. 1 is depicted as a full bridge switching circuit formed from a first half bridge that includes a first high-side switch 112 [Q1] and a first low-side switch 114 [Q2], and a second half bridge that includes a second high-side switch 116 [Q3] and a second low-side switch 118 [Q4]. In addition, in the non-limiting embodiment in FIG. 1, the rectifier circuit 108 is depicted as a full bridge rectifier that includes a first synchronous rectifier 120 [SR1], a second synchronous rectifier 122 [SR2], a first rectifying diode 124 [D1] and a second rectifying diode 126 [D2].

The switches of the switching circuit 104 are controlled in pairs. For example, when switch 112 [Q1] and switch 118 [Q4] are activated (or when switch 116 [Q3] and switch 114 [Q2] are activated), the primary power is delivered to the secondary side via the transformer 102 coupling. The primary current (Ip) can flow through a flow path that passes through the switch 112 [Q1] to the primary winding of the transformer 102 and then to the switch 118 [Q4] (or through a flow path that passes through switch 116 [Q3] to the primary winding of the transformer 102 and then to the switch 114 [Q2]). The primary power is delivered to the secondary side via the transformer 102 coupling, and then to the load.

The rectifier circuit 108 disposed on the secondary side of the power converter circuit 100 is configured as a full bridge rectifier with a pair of synchronous rectifiers, e.g., synchronous rectifier 120 and synchronous rectifier 122, and a pair of diodes, e.g., diode 124 and diode 126. The diodes 124 and 126 can be replaced with synchronous rectifiers to provide further efficiency improvements according to output voltage and current.

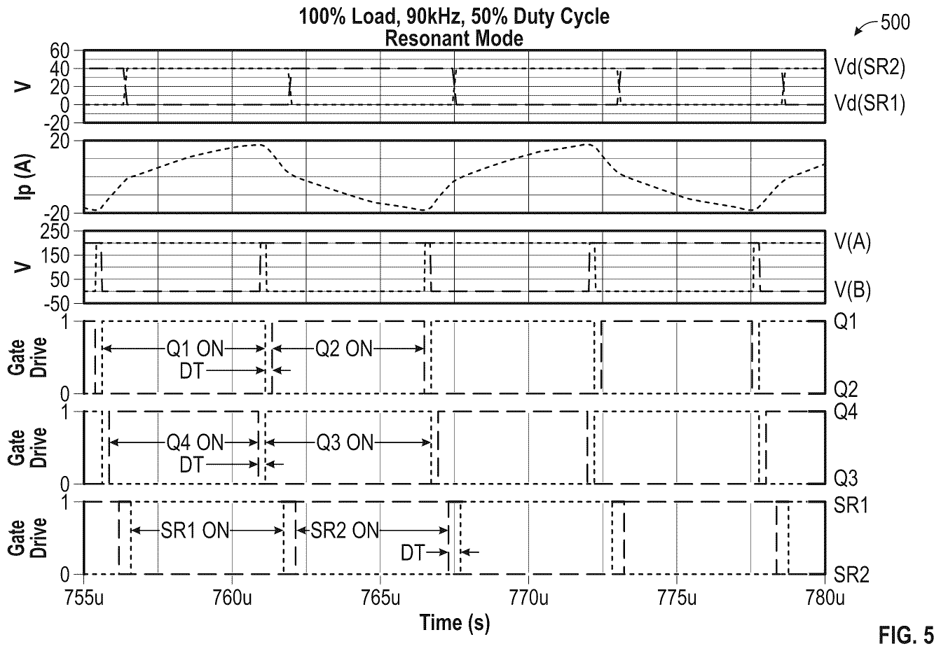

The load can be operated at full load. Generally, the switching circuit 104 of the power converter circuit 100 operates in a resonant mode when the rectifier circuit 108 provides the load with approximately 50% of the full load or greater, and the switching circuit 104 operates in the PWM mode when the rectifier circuit 108 provides the load with less than approximately 50% of the full load. In particular, as described in more detail below with reference to the timing diagrams in FIGS. 5-7, the switching circuit 104 operates in a resonant mode with zero voltage switching (ZVS) using a fixed duty cycle and a variable switching frequency that varies between a minimum frequency (Fmin) and a maximum frequency (Fmax) based on an amount of power output to the load above a threshold. In an exemplary embodiment, in the resonant mode, the fixed duty cycle is 49%, Fmin is about 90 kHz, and Fmax is about 150 kHz. As the load decreases to less than 50% of the full load, the switching circuit 104 operates in PWM mode with ZVS using a fixed switching frequency and a duty cycle that varies based on the amount of power output to the load below the threshold. In an exemplary embodiment, the fixed switching frequency (in PWM mode) is Fmax, e.g., 150 kHz, and the duty cycle is less than approximately 49%.

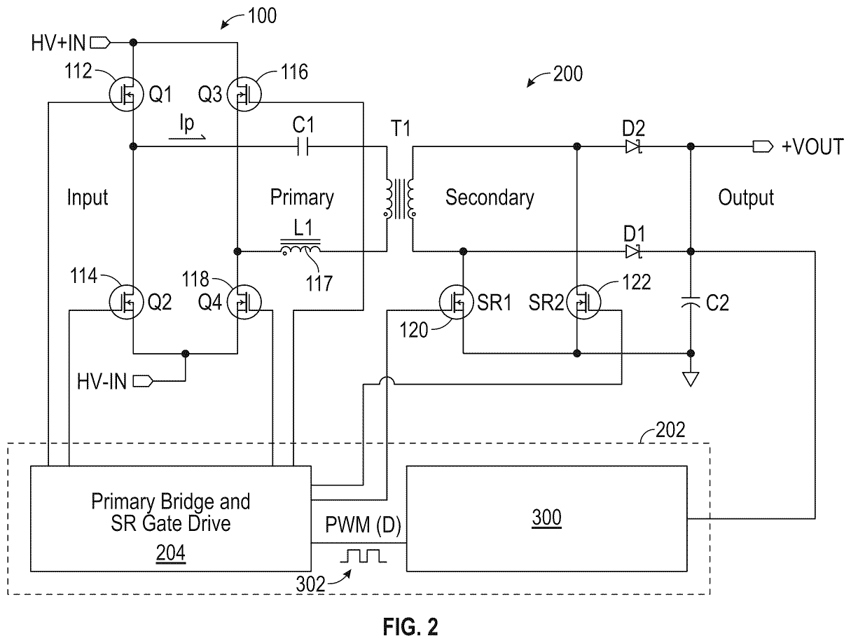

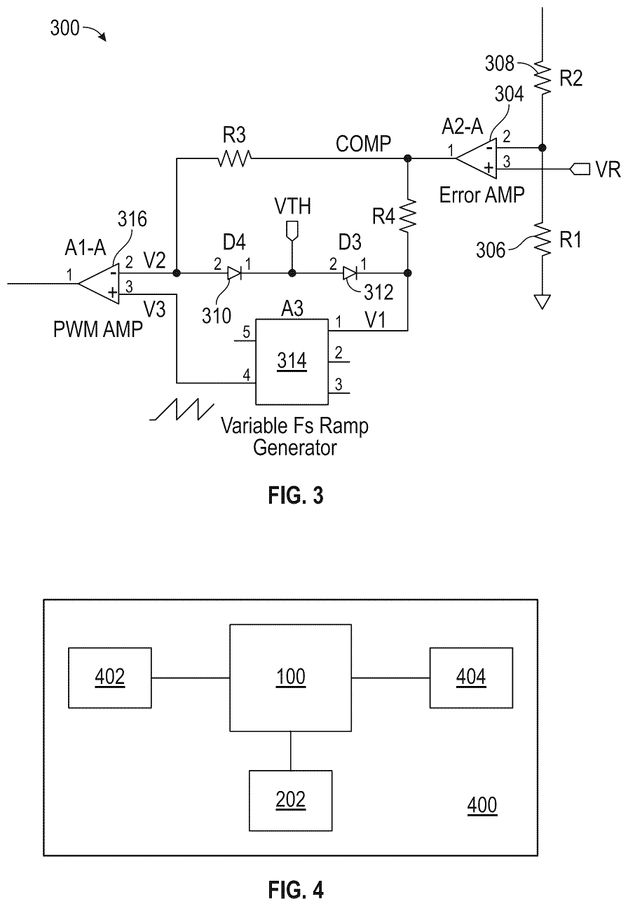

FIG. 2 is another schematic diagram of a circuit for configured to operate in a resonant mode and a forward pulse width modulation mode in accordance with an illustrative embodiment. The circuit 200 includes a power conversion circuit 100 connected to control circuitry 202. The control circuitry 202 depicted in FIG. 2 includes a switch control circuit 204 and an output voltage sensing circuit 300. A control signal 302 generated by the output voltage sensing circuit 300 is fed into the switch control circuit 200 and used to drive the switches 112 [Q1], 114 [Q2], 116 [Q3], and 118 [Q4] and the synchronous rectifiers 120 [SR1] and 122 [SR2]. The control signal 302 is generated by the output voltage sensing circuit 300 based on a threshold voltage (VTH) as described in more detail in FIG. 3 that follows.

FIG. 3 is a schematic diagram of an exemplary output voltage sensing circuit for controlling a circuit configured to operate in a resonant mode and a PWM mode in accordance with an illustrative embodiment. Generally, the output voltage sensing circuit 300 is used to sense the output voltage (Vout). The sensed signal is sent to an error amplifier 304, which compares this signal with the preset reference voltage (VR) so as to control the switch turn-on time. If Vout is below the desired setpoint, the error amplifiers output rises, which, if it is still below VTH (PWM mode), causes the controller to increase the switch turn-on time, Ton, and hence to increase the switch duty cycle (D), since Fs is fixed. If above VTH (resonant mode), the rise in error amplifier output causes the controller to decrease the switching frequency, since D is fixed, hence increasing the power transferred through the resonant circuit. Alternatively, if Vout is higher than the desired VR, the error amplifier's output drops to, if it is below VTH, reduce the switch turn-on time, reducing D, or if above VTH, to increase the switching frequency, hence decreasing the power transferred through the resonant circuit.

The output voltage sensing circuit 300 includes an error amplifier 304 with an output COMP that controls Fs and D of the power converter circuit 100. An output voltage regulation setpoint is established by the error amplifier 304 connected to VR and a pair of resistors 306 and 308 connecting the error amplifier 304 to the output of the power converter circuit 100. Diode 310 [D4] limits V2 max to a threshold voltage (VTH) and diode 312 [D3] limits V1 min to VTH. A variable frequency sawtooth generator 314 receives V1 at pin 1 to control Fs. An output of the variable frequency sawtooth generator 314, e.g., V3, is provided from pin 4 to a PWM controller 316 that compares V2 (COMP) to V3 (RAMP) and generates the PWM (D) waveform that is provided to the switch control circuit 200.

### Example Operation of Output Voltage Sensing Circuit

The output voltage sensing circuit 300 of FIG. 3 is configured to cause the power converter 100 to transition from resonant mode to forward PWM mode when COMP equals VTH, which is set to correspond to approximately 50% of the full load.

Exemplary operating parameters of output voltage sensing circuit 300 in FIG. 3 are provided below for describing an exemplary use case.

$$COMP = 0 V - 12 V \\ Duty cycle ( D ) = 1 \% - 50 \% \\ Switching frequency ( Fs ) = Fmin - Fmax \\ Fmin = 90 KHz \\ Fmax = 150 KHz \\ Reference voltage ( VR ) = 4 V \\ Threshold voltage ( VTH ) = 6 V$$

Generally, with VTH set to 6V, V2 varies from 0V-6V and V1 varies from 6V-12V, according to COMP. D varies with COMP, starting at approximately 1% (V2=COMP=0V) and increases linearly to approximately 49% (V2=COMP=6V). When COMP>6V, then V2 is maintained at 6V (VTH) and D is fixed at approximately 49%. Fs varies with V1, starting at Fmax (V1=VTH=6V) and decreases linearly to Fmin (V1=COMP=12V). Thus, in operation Fs varies from approximately 150 kHz to approximately 90 kHz as V1 varies from 6V to 12V. Fs is close to 150 kHz at light loads and close to 90 kHz at full load but may drop to approximately 80 kHz during load/voltage transients, or during hold up. D varies from approximately 49% (full to half load) to approximately 1% at no load.

### Example Operation of Power Converter Circuit

The proposed power converter circuit 100 operates in resonant mode for loads greater than approximately 50% of the full load. As load decreases below approximately 50% of the full load, the power converter circuit 100 changes to full bridge forward PWM mode (PWM mode) but without an output inductor, enabled by an overlap of the on times of the synchronous rectifiers 120 [SR1] and 122 [SR2]. Generally, a first low-side switch 114 [Q2] and a second low-side switch 118 [Q4] and a first synchronous rectifier 120 [SR1] and a second synchronous rectifier 122 [SR2] turn on and remain on during Toff in order to lock and continuously maintain the primary current (Ip). The same primary current flows through L1 which remains energized during Toff. When Toff expires, Ip forces the opposite side of the bridge to commutate, thereby achieving ZVS.

Exemplary operating parameters of a power converter circuit 100 are provided below for describing an exemplary use case.

$$Duty cycle ( D ) = 1 \% - 50 \% \\ Dead t ime ( DT ) = 400 ns . \\ Efficiency ( η ) = 98.3 \% \\ Full load = 2 kW \\ Switching frequency ( Fs ) = Fmin - Fmax \\ Fmin = 90 KHz \\ Fmax = 150 KHz \\ Output voltage ( Vout ) \\ Primary resonant frequency ( Fr ) = 60 kHz \\ Primary Series Impedence ( Zpri ) \\ Reference voltage ( VR ) = 4 V \\ Threshold voltage ( VTH ) = 6 V$$

### Resonant Mode

While the power provided to the load is approximately 50% of the full load or greater, the switching circuit 104 operates in the resonant mode with a fixed D=49%, and a variable Fs that varies between Fmin and Fmax based on load. At full load, Fs=Fmin=90 kHz, but which could dip to around 80 kHz during load/voltage transients, or during hold up. Fs increases as the load or desired Vout decreases to maintain regulation by increasing primary series impedance (Zpri) and eventually reaches Fs=Fmax=150 kHz. The timing diagram of the power converter circuit 100 operating in resonant mode is shown in FIG. 5. In particular, the timing diagram 500 illustrates the operation of the power converter circuit 100 operating at 100% of the full load, at Fs=Fmin=90 kHz, and a D of 50%.

### Resonant Mode and PWM Mode Boundary

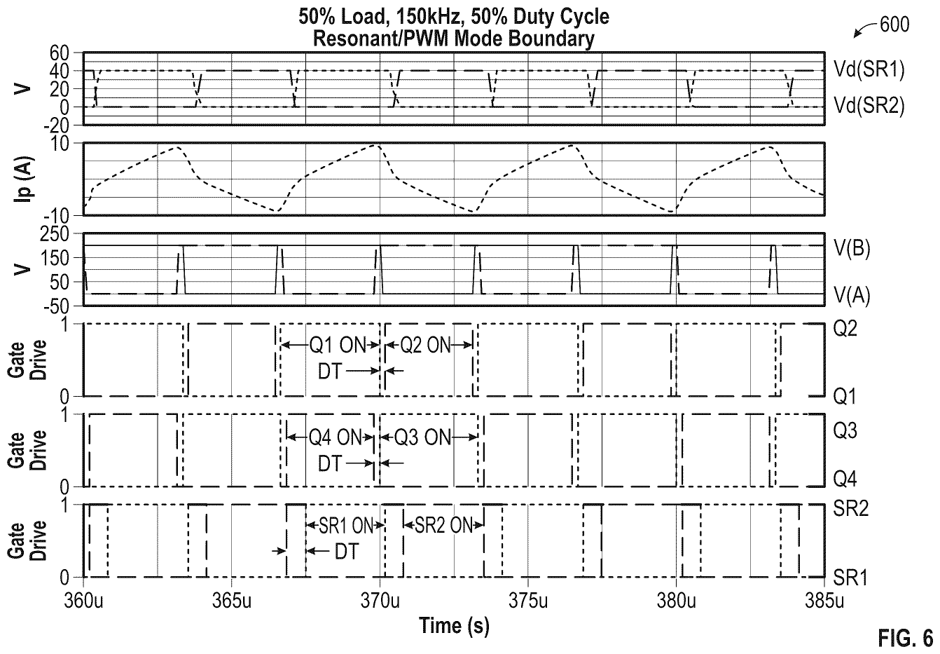

At around 50% load, Fs=150 kHz and Fs stops increasing and stays fixed. As load or desired Vout decreases further, D starts decreasing from 49% towards 1%. The operating mode now changes to PWM mode. The timing diagram of the power converter circuit 100 operating at the boundary between the resonant mode and the PWM mode is shown in FIG. 6. In particular, the timing diagram 600 illustrates the operation of the power converter circuit 100 operating at 50% of the full load, at Fs=Fmax=150 kHz, and a D of 50%.

### PWM Mode

Generally, as load or desired Vout decreases further, the on time of the first high-side switch 112 [Q1] and the second high-side switch 116 [Q3] decreases while the on time of the first low-side switch 114 [Q2] and the second low-side switch 118 [Q4] and the synchronous rectifiers 120 [SR1] and 122 [SR2] increases such that D decreases from 49% towards 1%.

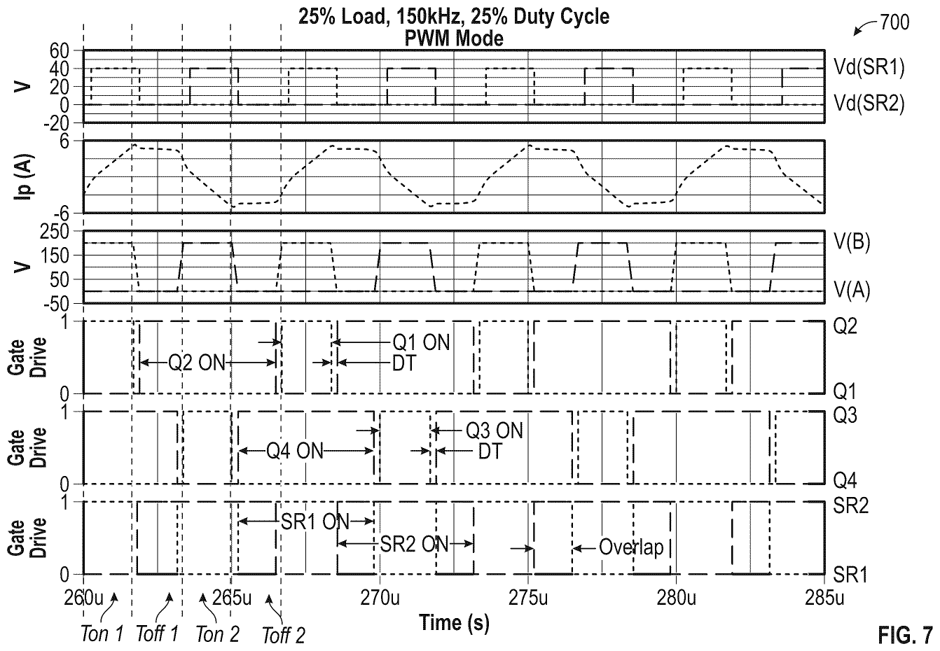

When power provided to the load is less 50% of the full load, the switching circuit 104 operates in PWM mode with a fixed Fs=150 kHz and a D that varies from 49% to 1% according to load and desired Vout. The timing diagram of the power converter circuit 100 operating in PWM mode is shown in FIG. 7. In particular, the timing diagram 700 illustrates the operation of the power converter circuit 100 operating at 25% of the full load, at Fs=Fmax=150 kHz, and a D of 25%. A complete power transfer cycle is formed from two complete ON-OFF cycles, i.e., Ton 1, Toff 1, Ton 2, and Toff 2 as indicated in timing diagram 700.

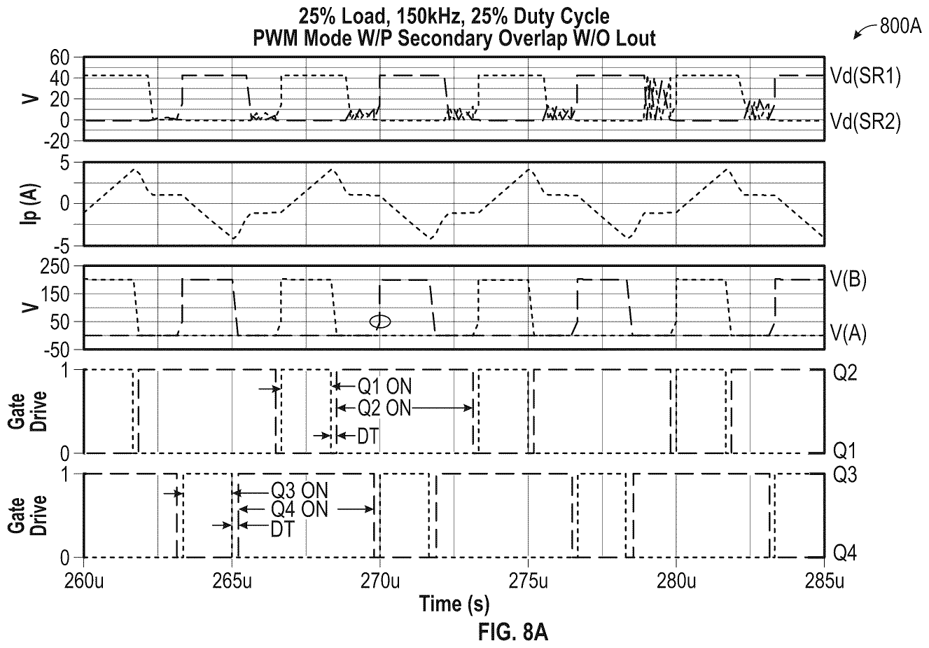

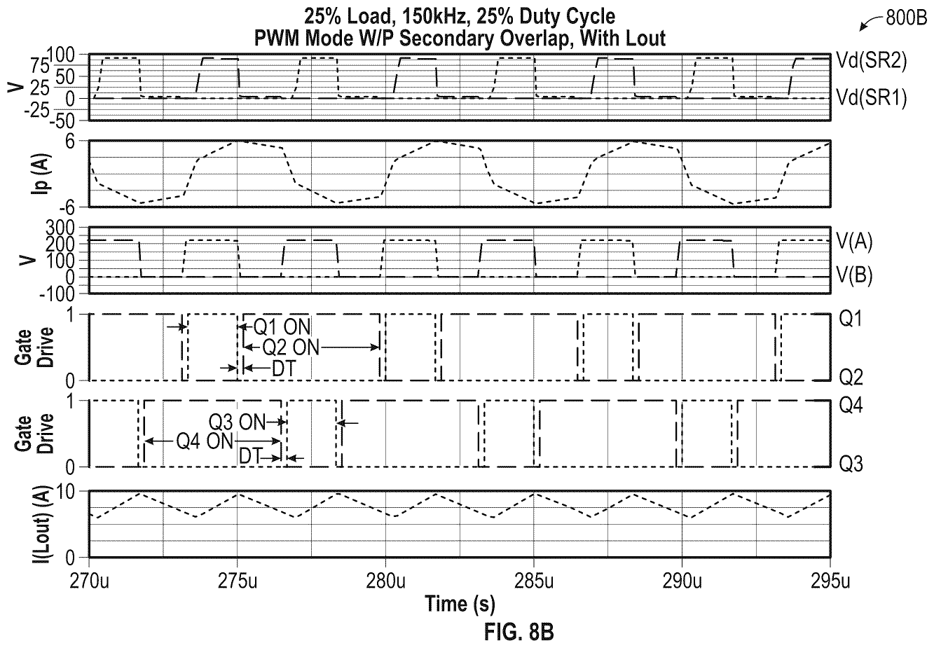

During Ton 1 at the beginning of the switching cycle, the first high-side switch 112 [Q1] and the second low-side switch 118 [Q4] are activated, the first synchronous rectifier 120 [SR1] has already been active and primary current (Ip) ramps up with time and according to load. At the end of Ton 1, the first high-side switch 112 [Q1] is deactivated, the second low-side switch 118 [Q4] and the first synchronous rectifier 120 [SR1] remain active, the first low-side switch 114 [Q2] and the second synchronous rectifier 122 [SR2] are activated after DT, and the first low-side switch 114 [Q2], the second low-side switch 118 [Q4], the first synchronous rectifier 120 [SR1], and the second synchronous rectifier 122 [SR2] remain active until the end of Toff 1. This action locks and maintains Ip and inductor 117 [L1] remains energized during Toff 1. The disadvantage of not locking and maintaining Ip during Toff during operation of the power converter circuit 100 can be seen in the timing diagram 800A in FIG. 8A. In particular, Ip collapses and ZVS is not maintained, which causes hard switching (as indicated by the circle) and ringing during Toff. Incorporating an output inductor into the power converter circuit 100 can improve the switching characteristics, as can be seen in the timing diagram 800B in FIG. 8B, at the expense of a slower transient response, decreased efficiency, and increased cost, size, and weight.

When Toff 1 expires, the first synchronous rectifier 120 [SR1] and the second low-side switch 118 [Q4] turn off, Ip discharges the second high-side switch 116 [Q3] Vds to zero, then the second high-side switch 116 [Q3] turns on after DT, thereby achieving ZVS. Thus, during Ton 2, the second high-side switch 116 [Q3], the first low-side switch 114 [Q2] and the second synchronous rectifier 122 [SR2] remain active. At the end of Ton 2, the second high-side switch 116 [Q3] is deactivated, and the second low-side switch 118 [Q4] and the first synchronous rectifier 122 [SR1] are activated after DT. Thus, during Toff 2, the first low-side switch 114 [Q2], the second low-side switch 118 [Q4], the first synchronous rectifier 120 [SR1], and the second synchronous rectifier 122 [SR2] are active.

This scheme achieves primary ZVS over a wide range of load and variable Vin/Vout ratios, while keeping Ip low (due to lower Imag) and only varying Fs from 90 kHz (Fmin) to 150 kHz (Fmax). Losses on the switching components and magnetics are reduced, it also allows for lower inductance on inductor 117 which further reduces losses. The absence of an output inductor makes transient response faster and reduces losses, cost, size & weight, it also reduces voltage stress on the secondary rectifiers. Voltage stress on the secondary rectifiers, e.g., synchronous rectifiers 120 and 122 and diodes 124 and 126, is limited to Vout, regardless of load. The power converter circuit 100 has a high efficiency (η>98%) due to retention of primary ZVS current, lower Fs, and lower Imag. Further, the power converter circuit 100 exhibits trapezoidal deep overload/short circuit current, ensuring safe, stable operation and ZVS.

FIG. 4 is a schematic diagram of an apparatus implementing a circuit configured to operate in a resonant mode and a forward pulse width modulation mode in accordance with an illustrative embodiment. The apparatus 400 is an electronic device powered by a power supply 402. Non-limiting examples of the apparatus 400 include an LED/LCD display, a vehicle charger, a telecommunication device, data communication equipment, a base-station and/or wireless equipment, semiconductor test equipment, factory automation equipment, robotic equipment, and transportation equipment. The apparatus 400 provides power to a load 404 operating at a predetermined power level that differs from the power level supplied by the power supply 402. Accordingly, the apparatus 400 includes a power converter circuit 100 to convert the supplied power to a predetermined level required by the load 404 electrically coupled with the power converter circuit 100.

Apparatus 400 also includes a control circuitry 202 connected to the power converter circuit 100 to cause the power converter circuit 202 to operate in either the resonant mode or the PWM mode. In this illustrative embodiment, the control circuitry 202 is depicted separately from the power converter circuit 100; however, in another embodiment the control circuitry 202 may be integrated with the power converter circuit 100.

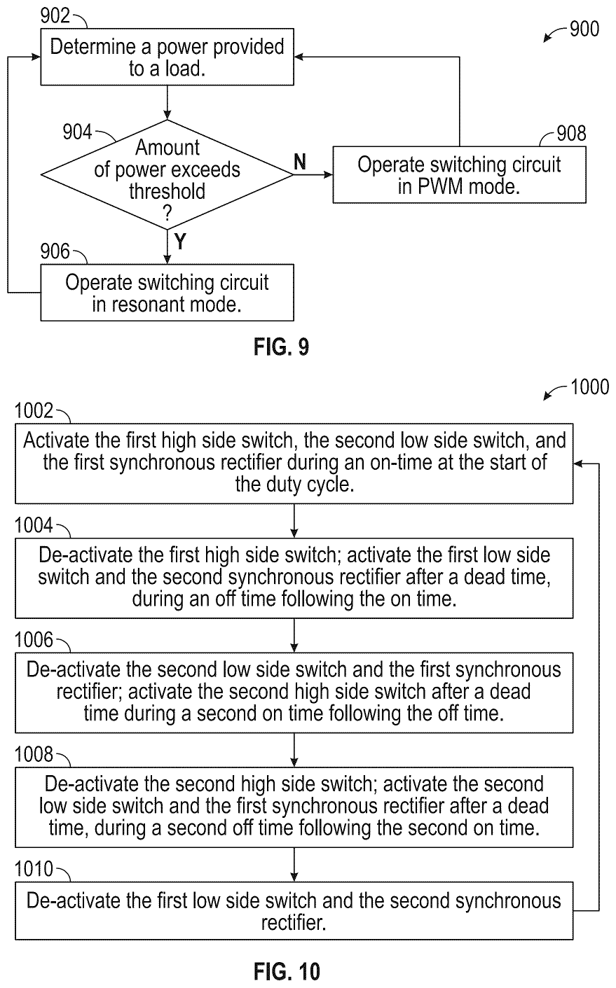

FIG. 9 is a flowchart of a process for operating the circuit of FIG. 1 in accordance with an illustrative embodiment. The steps of the flowchart 900 can be implemented by control circuitry, such as control circuitry 202 in FIG. 2.

The flowchart 900 begins at step 902 by determining the power provided to a load. In a non-limiting embodiment, the threshold is 50% load. In an illustrative embodiment, the load is configured to operate at a full load of 2 kW and the threshold of 50% load is 1 kW.

In step 904, a determination is made as to whether the power provided to the load is above threshold. If the amount of power consumption is determined to be above the threshold, i.e., the rectifier circuit is providing the load with approximately 50% load or greater, then flowchart 900 proceeds to step 906 where the switching signal is generated in a resonant mode with zero voltage switching (ZVS) using a fixed duty cycle and a variable switching frequency that varies between a minimum frequency (Fmin) and a maximum frequency (Fmax). In a non-limiting embodiment, step 906 includes maintaining the fixed duty cycle at 49% and the variable switching frequency between an Fmin of 90 kHz and an Fmax of 150 kHz.

In step 904, if the determination is made that the amount of power consumption is below the threshold, i.e., the rectifier circuit is providing the load with approximately 50% load or less, then flowchart 900 proceeds to step 908 where the switching signal is generated in PWM mode with ZVS using a fixed switching frequency and a duty cycle that varies based on the power provided to the load. In a non-limiting embodiment, step 908 can include maintaining the fixed switching frequency at Fmax and varying the duty cycle between 49% and 0%. Step 908 can also include locking a primary current (Ip) of the switching circuit during an OFF time (Toff) of the duty cycle, which causes an inductor of the resonant tank to remain energized by Ip during Toff.

FIG. 10 is a flowchart of a switching circuit operating in a PWM mode with ZVS in accordance with an illustrative embodiment. The steps of flowchart 1000 can be implemented by control circuitry, such as control circuitry 202 in FIG. 2. The switching circuit includes a first half bridge with a first high-side switch [Q1] and a first low-side switch [Q2], a second half bridge including a second high-side switch [Q3] and a second low-side switch [Q4]; and a rectifier circuit that includes a first synchronous rectifier [SR1], and a second synchronous rectifier [SR2], as shown in FIG. 2.

Flowchart 1000 begins at step 1002 by activating the first high-side switch [Q1], the second low-side switch [Q4], and the first synchronous rectifier [SR1] during an ON time, i.e., Ton, at a start of the duty cycle. In a non-limiting embodiment, the second low-side switch [Q4] and the first synchronous rectifier [SR1] are already activated from the previous switching cycle before Ton starts.

In step 1004, the first high-side switch [Q1] is deactivated, and the first low-side switch [Q2], the second low-side switch [Q4], the first synchronous rectifier [SR1], and the second synchronous rectifier [SR2] are activated during an OFF time, i.e., Toff, following Ton. In a non-limiting embodiment, the first low-side switch [Q2] and the second synchronous rectifier [SR2] activate after a dead time at an end of Ton, allowing Ip to discharge the first low-side switch [Q2] to zero volts, achieving ZVS The first synchronous rectifier [SR1] and second synchronous rectifier [SR2] being active at the same time preserves Ip from discharging during Toff so Ip can perform work at the end of Toff.

In step 1006, the second low-side switch [Q4] and the first synchronous rectifier [SR1] are deactivated, and the first low-side switch [Q2], the second high-side switch [Q3], and the second synchronous rectifier [SR2] are activated during a second Ton following Toff. In a non-limiting embodiment, the second high-side switch [Q3] activates after a dead time at the end of Toff, allowing Ip (preserved from step 1004) to discharge the second high-side switch [Q3] to zero volts, achieving ZVS.

In step 1008, the second high-side switch [Q3] is deactivated, and the first low-side switch [Q2], the second low-side switch [Q4], the first synchronous rectifier [SR1], and the second synchronous rectifier [SR2] are activated during a second Toff following the second Ton. In a non-limiting embodiment, the second low-side switch [Q4] and the first synchronous rectifier [SR1] activate after a dead time and the end of Ton, allowing Ip to discharge the second low-side switch [Q4] to zero volts, achieving ZVS. The first synchronous rectifier [SR1] and second synchronous rectifier [SR2] being active at the same time preserves Ip from discharging during Toff so Ip can perform work at the end of Toff.

In step 1010, at an expiration of the second Toff, the first low-side switch [Q2] and the second synchronous rectifier [SR2] are deactivated in preparation of return to step 1002. In a non-limiting embodiment, step 1002 is started after a dead time, allowing Ip (preserved from step 1008) to discharge the first high-side switch [Q1] to zero volts, achieving ZVS.

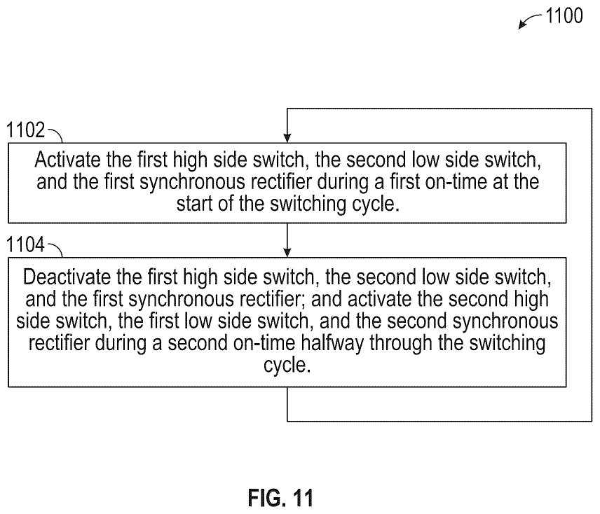

FIG. 11 is a flowchart of the switching circuit operating in resonant mode with ZVS in accordance with an illustrative embodiment. The steps of flowchart 1100 can be implemented by control circuitry, such as the control circuitry 202 in FIG. 2. The switching circuit includes a first half bridge with a first high-side switch [Q1] and a first low-side switch [Q2], a second half bridge including a second high-side switch [Q3] and a second low-side switch [Q4], and a rectifier circuit that includes a first synchronous rectifier [SR1], and a second synchronous rectifier [SR2], as shown in FIG. 2.

Flowchart 1100 begins at step 1102 by activating the first high-side switch [Q1], the second low-side switch [Q4], and the first synchronous rectifier [SR1] during an ON time at the start of a switching cycle. In a non-limiting embodiment, the first high-side switch [Q1], the second low-side switch [Q4], and the first synchronous rectifier [SR1] are activated after a dead time to allow Ip to discharge the first high side switch [Q1] and the second low-side switch [Q4] to zero volts, achieving ZVS.

In step 1104 the first high-side switch [Q1], the second low-side switch [Q4], and the first synchronous rectifier [SR1] deactivate, the second high-side switch [Q3], the first low-side switch [Q2], and the second synchronous rectifier [SR2] are activated to enable a second ON time starting halfway through the switching cycle. In a non-limiting embodiment, the second high-side switch [Q3], the first low-side switch [Q2] and the second synchronous rectifier [SR2] are activated after a dead time to allow Ip to discharge the second high-side switch [Q3], and the first low-side switch [Q2] to zero volts, achieving ZVS.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A power converter circuit comprising:
a transformer dividing the power converter circuit into a primary side and a secondary side;
a switching circuit disposed on the primary side; and
a rectifier circuit disposed on the secondary side and configured to provide power to a load; wherein:
the switching circuit operates in a resonant mode with zero voltage switching (ZVS) using a fixed duty cycle and a variable switching frequency that varies between a minimum frequency (Fmin) and a maximum frequency (Fmax) based on a power consumption of the load above a threshold, and
the switching circuit operates in a forward pulse width modulation (PWM) mode with ZVS using a fixed switching frequency and a duty cycle that varies based on the power consumption of the load below the threshold.

2. The power converter circuit of claim 1, wherein:
the fixed duty cycle is approximately 49%,
the fixed switching frequency is approximately Fmax, and
the duty cycle is greater than zero but less than approximately 49%.

3. The power converter circuit of claim 1, wherein Fmin is about 90 kHz and Fmax is about 150 kHz.

4. The power converter circuit of claim 1, wherein:
the load is operable at up to a full power level,
the switching circuit operates in the resonant mode when the rectifier circuit provides the load with approximately 50% to 100% of the full power level, and
the switching circuit operates in the forward PWM mode when the rectifier circuit provides the load with less than approximately 50% of the full power level.

5. The power converter circuit of claim 1, wherein:
the rectifier circuit further comprises an output capacitor configured to transfer energy to the load, and
the rectifier circuit does not include an inductor.

6. The power converter circuit of claim 1, further comprising:
a resonant tank disposed on the primary side and coupled to the switching circuit and a primary winding of the transformer.

7. The power converter of claim 6, wherein:
a primary current of the switching circuit is locked during an OFF time of the duty cycle, and
the resonant tank includes an inductor configured to remain energized by the primary current during the OFF time.

8. The power converter circuit of claim 1, wherein:
the switching circuit comprises:
a first half bridge that includes a first high-side switch and a first low-side switch,
a second half bridge that includes a second high-side switch and a second low-side switch; and
the rectifier circuit comprises:
a first synchronous rectifier, and
a second synchronous rectifier.

9. The power converter circuit of claim 8, wherein when operating in PWM mode:
during an ON time at a start of the switching cycle, the first high-side switch, the second low-side switch, and the first synchronous rectifier are activated,
during an OFF time following the ON time, the first low-side switch, the second low-side switch, the first synchronous rectifier, and the second synchronous rectifier are activated,
during a second ON time following the OFF time, the first low-side switch, the second high-side switch, and the second synchronous rectifier are activated, and
during a second OFF time following the second ON time, the first low-side switch, the second low-side switch, the first synchronous rectifier, and the second synchronous rectifier are activated.

10. The power converter circuit of claim 9, wherein:
during the OFF time prior to the start of the switching cycle, the first synchronous rectifier activates after a dead time,
at an end of the ON time, the second synchronous rectifier is activated after a dead time to achieve ZVS.

11. The power converter circuit of claim 10, wherein:
at an expiration of the OFF time, the first synchronous rectifier and the second low-side switch are deactivated, and
the second high-side switch and first low-side switch are discharged to zero volts and then activated after a dead time to achieve the ZVS.

12. The power converter circuit of claim 8, wherein when operating in resonant mode:
during an ON time at a start of the switching cycle, the first high-side switch, the second low-side switch, and the first synchronous rectifier are activated, and
during a second ON time following the OFF time, the first low-side switch, the second high-side switch, and the second synchronous rectifier are activated.

13. The power converter circuit of claim 12, wherein:
during the first ON time at the start of the switching cycle, the first synchronous rectifier activates after a dead time, and
during the second ON time, approximately halfway through the switching cycle, the second synchronous rectifier is activated after a dead time.

14. The power converter circuit of claim 13, wherein:
at the expiration of the first ON time, the first high-side switch, the second low-side switch are deactivated,
the second high-side switch and first low-side switch are discharged to zero volts and then activated after a dead time to achieve the ZVS and begin the second ON time,
the first synchronous rectifier is deactivated after a dead time,
the second synchronous rectifier is activated after a dead time,
at the expiration of the second ON time, the first low-side switch the second high-side switch are deactivated,
the first high-side switch and the second low-side switch are activated after a dead time to achieve ZVS and begin the next first ON time,
the second synchronous rectifier is deactivated after a dead time, and
the first synchronous rectifier is activated after a dead time.

15. An apparatus comprising:
a power supply;
a power converter circuit receiving power from the power supply, the power converter circuit comprising:
a transformer dividing the power converter circuit into a primary side and a secondary side;
a switching circuit disposed on the primary side; and
a rectifier circuit disposed on the secondary side and configured to provide the power to a load; wherein:
the switching circuit operates in a resonant mode with zero voltage switching (ZVS) using a fixed duty cycle and a variable switching frequency that varies between a minimum frequency (Fmin) and a maximum frequency (Fmax) based on a power consumption of the load being above a threshold, and
the switching circuit operates in a forward pulse width modulation (PWM) mode with ZVS using a fixed switching frequency and a duty cycle that varies based on the power consumption of the load being below the threshold.

16. The apparatus of claim 15, wherein:
the fixed duty cycle is approximately 49%,
the fixed switching frequency is Fmax, and
the duty cycle is greater than zero but less than approximately 49%.

17. The apparatus of claim 15, wherein Fmin is about 90 kHz and Fmax is about 150 kHz.

18. The apparatus of claim 15, wherein:
the load is operable at up to a full power level,
the switching circuit operates in the resonant mode when the rectifier circuit provides the load with approximately 50% to 100% of the full power level, and
the switching circuit operates in the forward PWM mode when the rectifier circuit provides the load with less than approximately 50% of the full power level.

19. The apparatus of claim 15, wherein:
the rectifier circuit further comprises an output capacitor configured to transfer energy to the load, and
the rectifier circuit does not include an inductor.

20. The apparatus of claim 15, further comprising:
a resonant tank disposed on the primary side and coupled to the switching circuit and a primary winding of the transformer.

21. The apparatus of claim 20, wherein:
a primary current of the switching circuit is locked during an OFF time of the duty cycle, and
the resonant tank includes an inductor configured to remain energized by the primary current during the OFF time.

22. The apparatus of claim 15, wherein:
the switching circuit comprises:
a first half bridge that includes a first high-side switch and a first low-side switch,
a second half bridge that includes a second high-side switch and a second low-side switch; and
the rectifier circuit comprises:
a first synchronous rectifier, and
a second synchronous rectifier.

23. The apparatus of claim 22, wherein when operating in PWM mode:
during an ON time at a start of the switching cycle, the first high-side switch, the second low-side switch, and the first synchronous rectifier are activated,
during an OFF time following the ON time, the first low-side switch, the second low-side switch, the first synchronous rectifier, and the second synchronous rectifier are activated,
during a second ON time following the OFF time, the first low-side switch, the second high-side switch, and the second synchronous rectifier are activated, and
during a second OFF time following the second ON time, the first low-side switch, the second low-side switch, the first synchronous rectifier, and the second synchronous rectifier are activated.

24. The apparatus of claim 23, wherein:
during the OFF time prior to the start of the switching cycle, the first synchronous rectifier activates after a dead time,
at an end of the ON time, the second synchronous rectifier is activated after a dead time to achieve ZVS

25. The apparatus of claim 24, wherein:
at an expiration of the OFF time, the first synchronous rectifier and the second low-side switch are deactivated, and
the second high-side switch is discharged to zero volts and then activated after a dead time to achieve the ZVS.

26. The power converter circuit of claim 22, wherein when operating in resonant mode:
during an ON time at a start of the switching cycle, the first high-side switch, the second low-side switch, and the first synchronous rectifier are activated, and
during a second ON time following the OFF time, the first low-side switch, the second high-side switch, and the second synchronous rectifier are activated.

27. The power converter circuit of claim 26, wherein:
during the first ON time at the start of the switching cycle, the first synchronous rectifier activates after a dead time, and
during the second ON time, approximately halfway through the switching cycle, the second synchronous rectifier is activated after a dead time.

28. The power converter circuit of claim 27, wherein:
at the expiration of the first ON time, the first high-side switch, the second low-side switch are deactivated,
the second high-side switch and first low-side switch are discharged to zero volts and then activated after a dead time to achieve the ZVS and begin the second ON time,
the first synchronous rectifier is deactivated after a dead time,
the second synchronous rectifier is activated after a dead time,
at the expiration of the second ON time, the first low-side switch the second high-side switch are deactivated,
the first high-side switch and the second low-side switch are activated after a dead time to achieve ZVS and begin the next first ON time,
the second synchronous rectifier is deactivated after a dead time, and
the first synchronous rectifier is activated after a dead time.

29. A method of operating a power converter circuit including switching circuit, transformer, and rectifier circuit configured to provide power to a load, the method comprising:
determining an amount of power consumption of the load relative to a threshold;
responsive to determining that the amount of power consumption is above the threshold, operating the switching circuit in a resonant mode with zero voltage switching (ZVS) using a fixed duty cycle and a variable switching frequency that varies between a minimum frequency (Fmin) and a maximum frequency (Fmax) based on the amount of the power consumption of the load; and
responsive to determining that the amount of power consumption is below the threshold, operating the switching circuit in a forward pulse width modulation (PWM) mode with ZVS using a fixed switching frequency and a duty cycle that varies based on the amount of the power consumption of the load.

30. The method of claim 29, wherein:
causing the switching circuit to operate in the resonant mode includes maintaining the fixed duty cycle at approximately 49%, and
causing the switching circuit to operate in the forward PWM mode includes maintaining the fixed switching frequency at Fmax and varying the duty cycle less than approximately 49% but greater than 0%.

31. The method of claim 29, wherein Fmin is about 90 kHz and Fmax is about 150 KHz.

32. The method of claim 29, wherein:
determining that the amount of the power consumption is above the threshold further comprises determining that the rectifier circuit is providing the load with approximately 50% to 100% of a full power level of the load, and
determining that the amount of the power consumption is below the threshold further comprises determining that the rectifier circuit is providing the load with less than approximately 50% of the full power level of the load.

33. The method of claim 29, wherein:
the rectifier circuit further comprises an output capacitor configured to transfer energy to the load, and
the rectifier circuit does not include an inductor.

34. The method of claim 29, further comprising:
a resonant tank disposed on the primary side and coupled to the switching circuit and a primary winding of the transformer.

35. The method of claim 34, further comprising:
locking a primary current of the switching circuit during an OFF time of the duty cycle, wherein the resonant tank includes an inductor configured to remain energized by the primary current during the OFF time.

36. The method of claim 29, wherein:
the switching circuit comprises:
a first half bridge that includes a first high-side switch and a first low-side switch,
a second half bridge that includes a second high-side switch and a second low-side switch; and
the rectifier circuit comprises:
a first synchronous rectifier, and
a second synchronous rectifier.

37. The method of claim 36, wherein causing the switching circuit to operate in the forward PWM mode further comprises:
activating the first high-side switch, the second low-side switch, and the first synchronous rectifier during an ON time at a start of the switching cycle;
activating the first low-side switch, the second low-side switch, the first synchronous rectifier, and the second synchronous rectifier during an OFF time following the ON time;
activating the first low-side switch, the second high-side switch, and the second synchronous rectifier during a second ON time following the OFF time; and
activating the first low-side switch, the second low-side switch, the first synchronous rectifier, and the second synchronous rectifier during a second OFF time following the second ON time.

38. The method of claim 37, wherein:
during the OFF time prior to the start of the switching cycle, the first synchronous rectifier activates after a dead time, and
at an end of the ON time, the second synchronous rectifier activates after a dead time to achieve ZVS.

39. The method of claim 38, further comprising:
deactivating the first synchronous rectifier and the second low-side switch at an expiration of the OFF time; and
discharging the second high-side switch to zero volts before activating the second high-side switch after a dead time to achieve the ZVS.

40. The method of claim 36, wherein causing the switching circuit to operate in the resonant mode further comprises:
activating the first high-side switch, the second low-side switch, and the first synchronous rectifier during a first ON time at a start of the switching cycle; and
activating the first low-side switch, the second high-side switch, and the second synchronous rectifier during a second ON time following the first ON time.

41. The method of claim 40, wherein causing the switching circuit to operate in the resonant mode further comprises:
during the first ON time at the start of the switching cycle, activating the first synchronous rectifier after a dead time; and
at an end of the first ON time, activating the second synchronous rectifier after a dead time.

42. The method of claim 41, wherein causing the switching circuit to operate in the resonant mode further comprises:
at the expiration of the first ON time, deactivating the first high-side switch and the second low-side switch;
discharging the second high-side switch and first low-side switch to zero volts and then activating the second high-side switch and the first low-side switch after a dead time to achieve the ZVS and begin the second ON time;
deactivating the first synchronous rectifier after a dead time;
activating the second synchronous rectifier after a dead time;
at the expiration of the second ON time, deactivating the first low-side switch the second high-side switch;
activating the first high-side switch and the second low-side switch after a dead time to achieve ZVS and begin the next first ON time;
deactivating the second synchronous rectifier after a dead time; and
activating the first synchronous rectifier after a dead time.

43. The method of claim 42, wherein causing the switching circuit to operate in the resonant mode further comprises:
deactivating the first synchronous rectifier and the second low-side switch at an expiration of the OFF time; and
discharging the second high-side switch to zero volts before activating the second high-side switch after a dead time to achieve the ZVS.
